(19) United States
(12) Patent Application Publication
(10) Pub. No.: US 2003/0231249 A1
(43) Pub. Date: Dec. 18, 2003

(54) Digital camera system

(75) Inventor: Hiroaki Nakamura, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD., Kanagawa (JP)

(21) Appl. No.: 10/458,242

(22) Filed: Jun. 11, 2003

(30) Foreign Application Priority Data
Jun. 12, 2002 (JP) 2002-171451
May 14, 2003 (JP) 2003-135354

(51) Int. Cl. H04N 5/225

(52) U.S. Cl. 348/231.99

(57) ABSTRACT

According to the present invention, there is provided a memory card for a digital camera, in which even an image photographed by a general-purpose digital camera can be authenticated at an authentication center. The memory card encrypts the image data photographed by a digital camera with an encryption key unique to the memory card, and then, records it in the memory card. The encrypted image data is read by a user computer, and then, is transmitted to an authentication center. The authentication center decrypts the image data transmitted with a decryption key corresponding to the memory card, and then, registers. In the case of a request for an authentication on an authentication request side, the image data transmitted on the authentication request side is compared with the registered image data, so that the comparison result is notified onto the authentication request side.

### CROSS-REFERENCE TO RELATED APPLICATION

This application claims priority under 35USC 119 from Japanese Patent Applications No. 2002-171451 and No. 2003-135354, the disclosures of which are incorporated by reference herein.

### BACKGROUND OF THE INVENTION

1. Field of the Invention

The present invention relates to a memory card for a digital camera, a digital camera system including the memory card for a digital camera, a recording method in the memory card, and an authenticating method in the digital camera system. More particularly, the invention relates to a memory card for a digital camera for recording image data on an image photographed by a digital camera, a digital camera system including the memory card for a digital camera, an image data recording method in the memory card, and an image data authenticating method in the digital camera system.

2. Description of the Related Art

In recent years, there have been prevailed numerous digital cameras provided with an image pickup device such as a CCD. In such a digital camera, an image of a subject time of photographing, and then, is converted into a signal electric charge in quantity according to an incident intensity by each of sensors in the CCD. The signal electric charge accumulated in the CCD is read per pixel, to be then converted into image data, which is then recorded in a storage medium such as a memory card. Furthermore, there has been conventionally proposed a cellular telephone or the like mounting thereon a digital camera due to miniaturization of the CCD or the like (see, for example, Japanese Patent Application Laid-open (JP-A) No. 6-233020).

In the above-described digital camera, the image data on the photographed image can be readily obtained more than in a silver-halide film camera; to the contrary, the image data can be processed with ease. Therefore, when an image of, for example, an incident location or an accident location photographed by the digital camera is used as evidence, the image data may be possibly falsified. Thus, the image data cannot be used as the evidence.

In order to solve the above-described problem, there has been proposed an authentication system, in which a digital camera is provided with an encrypting function, a photographed image is encrypted, to be then transmitted to and registered in an authentication center, and further, the authentication center authenticates the image data requested for the authentication based on the registered image data in the case where the authentication of the image data is requested at the authentication center, and thus, an image photographed by the digital camera can be used as evidence.

However, the above-described prior art has raised a problem in that, since the digital camera need be provided with the encrypting function, only an image photographed by a special digital camera can be authenticated.

### SUMMARY OF THE INVENTION

The present invention has been accomplished in an attempt to solve the above problems observed in the prior art. An object of the invention is to provide a memory card for a digital camera, in which even an image photographed by a general-purpose digital camera can be authenticated at an authentication center.

In order to achieve the above-described object, a first aspect of the invention provides a memory card for a digital camera, for recording data of an image photographed using a digital camera, the memory card for a digital camera comprising: an encryption component for encrypting the image data using a predetermined algorithm; and a storage component for storing the image data encrypted by the encryption component.

According to the invention, the encryption component encrypts the data of the image obtained by a pick-up component of the digital camera picking up a subject, according to the predetermined algorithm. The digital camera temporarily stores the image data in a memory for temporarily storing the image data therein, and then, transmits it directly to the memory card. The transmission may be performed at timing immediately after the picking-up or after a passage of a certain period of time. In this manner, the digital camera transmits the image data directly to the memory card, so that the image data cannot be fetched to the outside before the image data is stored in the memory card, and further, can be prevented from being falsified.

Moreover, the storage component stores therein the image data encrypted by the encryption component.

In this manner, the image picked up by the digital camera is directly received, encrypted and stored, so that the image can be prevented from being readily falsified. Therefore, in the case where the picked-up image is used as various kinds of evidences, the reliability can be enhanced. Even an image photographed by a general-purpose digital camera provided with no encrypting function can be used as various kinds of evidences.

The encryption component, for example, performs the encryption in encryption which can be decrypted at an authentication center for registering offered image data, so as to supply, onto an authentication request side, the comparison result of image data requested for the authentication on the authentication request side with the registered image data. Consequently, the image data stored in the storage component is decrypted and registered at the authentication center.

Furthermore, in the case where the authentication is requested on the authentication request side, the image data relevant to the authentication request is compared with the registered image data. Thereafter, information including, for example, the comparison result as to whether or not both of the image data match each other is supplied to the authentication request side.

In this manner, the image data to be authenticated is decrypted at the authentication center by encrypting the image data in encryption, which can be decrypted at the authentication center.

Additionally, in this case, it is preferable that the encryption component should encrypt the image data with an encryption key unique to the memory card for the digital camera; and the authentication center should decrypt the image data with a decryption key corresponding to the encryption key. Thus, it is possible to enhance the concealment of the image data.

A second aspect of the present invention provides a memory card for a digital camera, for recording data of an image photographed by a digital camera, the memory card for a digital camera comprising: an encryption program storage component for storing therein, in advance, an encryption program, on the basis of which the image data is encrypted using a predetermined algorithm; a transmission/reception component for transmitting the encryption program to the digital camera at the request of the digital camera and receiving the image data encrypted by the digital camera; and an image data storage component for storing the encrypted image data therein.

According to the second aspect of the present invention, the encryption program storage component previously stores therein the encryption program, based on which the image data is encrypted according to the predetermined algorithm. In the case where the digital camera requests for the transmission of the encryption program, the encryption program is transmitted to the digital camera by the transmission/reception component. Consequently, the image data on the photographed image is decrypted by using the received encryption program in the digital camera, and then, is transmitted to the memory card for the digital camera. The encrypted image data transmitted from the digital camera is received by the transmission/reception component, and then, is stored in the image data storage component.

In this manner, the encryption program is transmitted to the digital camera, and then, the image data is encrypted on the side of the digital camera. Therefore, the encryption component can be omitted, thereby achieving the simple configuration at a reduced cost.

A third aspect of the present invention provides a method of recording, in a memory card for a digital camera, data of an image photographed by a digital camera, the recording method comprising the steps of: (a) encrypting the image data with a predetermined algorithm; and (b) storing the encrypted image data.

A fourth aspect of the present invention provides a method of recording, in a memory card for a digital camera, data of an image photographed by a digital camera, the method comprising the steps of: storing, in advance, an encryption program, on the basis of which the image data is encrypted with a predetermined algorithm; transmitting the encryption program to the digital camera at the request of the digital camera and receiving the image data encrypted by the digital camera; and string the encrypted image data.

A fifth aspect of an authentication system for authenticating image data, the authentication system comprising: a digital camera for photographing image data; a memory card for receiving the photographed image data from the digital camera, encrypting the image data using a predetermined algorithm, and recording the image data; an authentication center for decrypting the encrypted image data, and registering the image data; and a computer on an authentication request side, for requesting the authentication center to authenticate the image data; wherein the authentication center transmits, to the computer on the authentication request side, a comparison result of the image data for which authentication has been requested by the computer on the authentication request side with the registered image data.

A sixth aspect of the present invention provides a method of authenticating image data comprising, the method comprising the steps of: (a) photographing image data using a digital camera; (b) receiving the photographed image data via a memory card; (c) encrypting the received image data using a predetermined algorithm via the memory card and recording the image data in the memory card; (d) decrypting the encrypted image data using an authentication center and registering the decrypted image data at the authentication center; (e) requesting the authentication center to authenticate the image data, using a computer on an authentication request side; and (f) transmitting, to the computer on the authentication request side, a comparison result of the image data for which authentication has been requested by the computer on the authentication request side with the registered image data, by the authentication center.

As described above, according to the invention, it is possible to produce an excellent effect that even the image photographed by the general-purpose digital camera can be authenticated at the authentication center.

### BRIEF DESCRIPTION OF THE DRAWINGS

FIG. 1 is a diagram illustrating a schematic configuration of an authentication system of a first embodiment of the present invention.

FIG. 2 is a diagram illustrating a schematic configuration of a network system, to which the authentication system of the first embodiment of the present invention is applied.

FIG. 3 is a block diagram illustrating a digital camera of the first embodiment of the present invention.

FIG. 4 is a block diagram schematically illustrating a memory card of the first embodiment of the present invention.

FIG. 5 is a block diagram illustrating a computer on a side of an authentication center of the first embodiment of the present invention.

FIG. 6 is a flowchart illustrating a processing routine to be executed in the digital camera of the first embodiment of the present invention.

FIG. 7 is a flowchart illustrating a processing routine to be executed in the memory card of the first embodiment of the present invention.

FIG. 8 is a flowchart illustrating a processing routine to be executed in the computer on the side of the authentication center of the first embodiment of the present invention.

FIG. 9 is a diagram illustrating a schematic configuration of a conventional authentication system.

FIG. 10 is a diagram illustrating the schematic configuration of an authentication system in a second embodiment of the present invention.

FIG. 11 is a block diagram schematically illustrating a memory card in the second embodiment of the present invention.

FIG. 12 is a flowchart illustrating a processing routine to be executed in a digital camera in the second embodiment of the present invention.

FIG. 13 is another flowchart illustrating a processing routine to be executed in the digital camera in the second embodiment of the present invention; and

FIG. 14 is a flowchart illustrating a processing routine to be executed in the memory card in the second embodiment of the present invention.

### DETAILED DESCRIPTION OF THE INVENTION

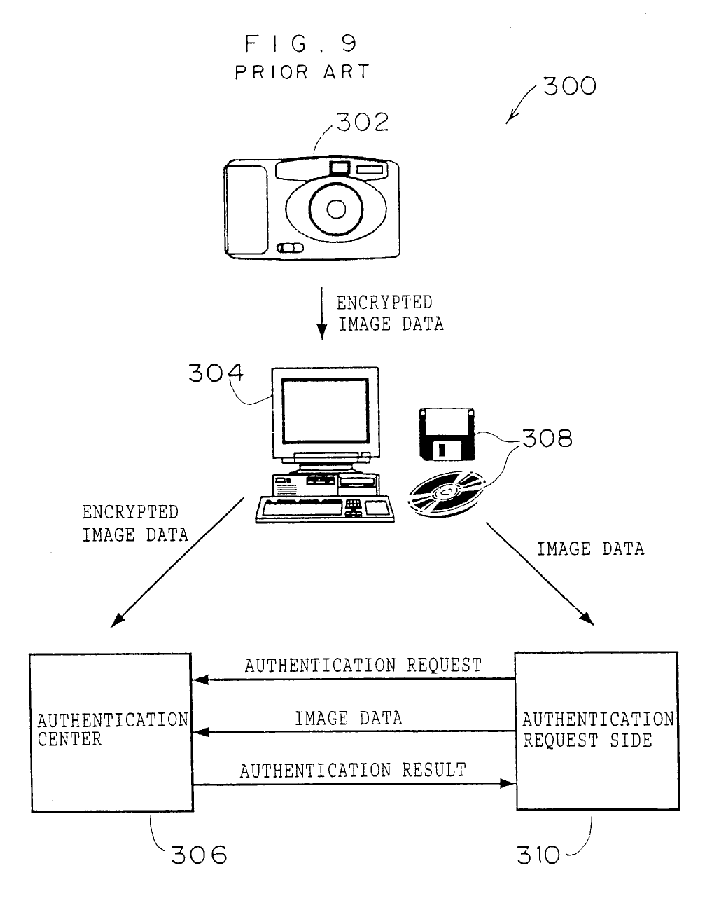

For comparison with the present invention, an authentication system in the prior art will be first explained with reference to FIG. 9. In an authentication system 300 illustrated in FIG. 9, a digital camera 302 is provided with a function of encrypting image data on a photographed image (for example, an image of an incident location or an accident location). The image photographed by the digital camera 302 is encrypted, and then, is taken in a personal computer 304 possessed by a user of the digital camera 302, and thus, is transmitted to an authentication center 306 via a network by the personal computer 304.

Furthermore, image data photographed by the digital camera 302 is recorded in a storage medium 308 such as a flexible disk or a CD-R by the personal computer 304, and is supplied to an authentication request side 310, if necessary. Here, examples of the authentication request side 310 include a courthouse, at which a photographed image of an incident location or the like is used as materials of a case, or an insurance office, at which a photographed image of an accident location or the like is used as materials for judging the payment of the insurance.

The authentication center 306 is provided with a function capable of decrypting the encrypted image data by the digital camera 302, and therefore, decrypts and registers the transmitted image data. The image data is supplied from the authentication request side 310, and is compared with the registered image data at the authentication request. If both of the image data match each other, an authentication result that the image data requested for the authentication is original image data is notified to the authentication request side 310. In contrast, unless both of the image data match each other, an authentication result that the image data requested for the authentication is not the original image data is notified to the authentication request side 310.

As is obvious from the above description, the authentication system in the prior art is configured such that the digital camera is provided with the encrypting function, the photographed image is encrypted, and then, transmitted to and registered in the authentication center; and further, that in the case where the authentication center is requested to authenticate the image data, the image data requested for the authentication is authenticated based on the image data registered in the authentication center, so that the image photographed by the digital camera can be used as evidence.

However, in the above-described prior art, there has arisen a problem that since the digital camera must be provided with the encrypting function, only the image photographed by the special digital camera can be authenticated.

An embodiment according to the invention will be described below with reference to the accompanying drawings. In the present embodiment, the invention is applied to a digital camera.

(First Embodiment)

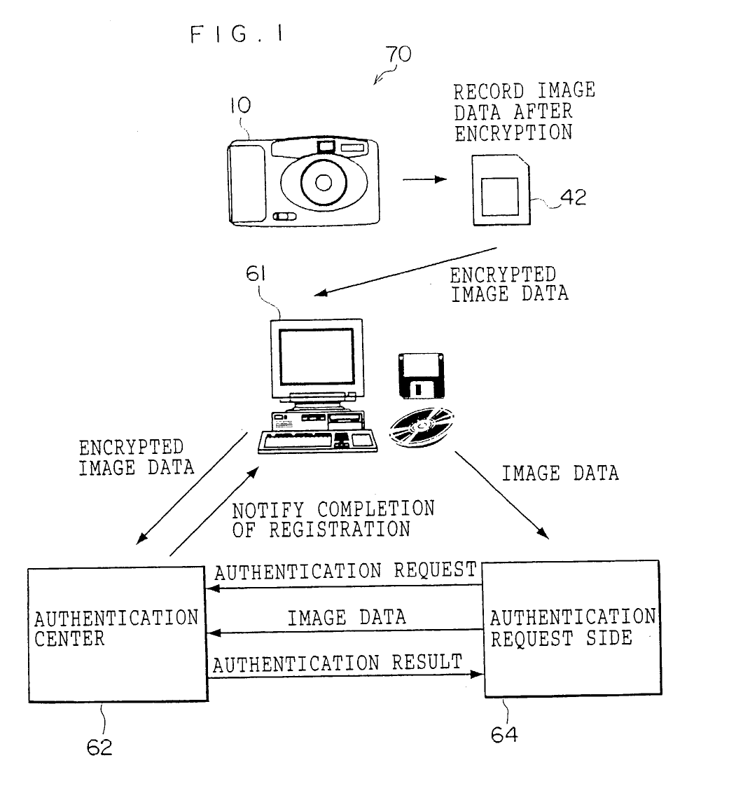

FIG. 1 is a diagram conceptually illustrating the schematic configuration of an authentication system in an embodiment. In an authentication system 70 illustrated in FIG. 1, data on an image photographed by a digital camera 10 is recorded in a memory card 42.

The memory card 42 is provided with a function of encrypting the image data transmitted from, for example, the digital camera 10 with an encryption key unique to the memory card 42, for example, an encryption key assigned according to the serial number of the memory card 42, although the details will be described later. The encrypted image data recorded in the memory card 42 can be read out by a user computer 61 possessed by a user of the digital camera 10 and the memory card 42.

The user computer 61 can transmit the image data read from the memory card 42 to an authentication center 62. The authentication center 62 decrypts the image data transmitted from the user computer 61 with a decryption key corresponding to the memory card 42, and then, registers the decrypted image data. And then, the authentication center 62 notifies the user computer 61 of the completion of the registration.

Incidentally, the system of the encryption and decryption may be achieved by, for example, a common key system or a public key system, or by using an electronic signature or the like.

In the case where the user desires to use the data on the photographed image as evidence, the image data is supplied to an authentication request side 64. The supplied image data is transmitted to the authentication center 62 if it is required to be confirmed as to whether or not the supplied image data is reliable, and then, authentication is requested on the authentication request side 64.

At the authentication center 62, the image data transmitted from the authentication request side 64 is compared with the registered image data. Thereafter, the comparison result, that is, information on whether or not the image data transmitted from the authentication request side 64 is original image data is notified as an authentication result to the authentication request side 64. Thus, it can be readily determined on the authentication request side 64 as to whether or not the image data supplied from the user of the digital camera 10 is reliable as the evidence.

In this manner, since the memory card 42 is provided with the encrypting function, the photographed image can be used for the authentication even if a general-purpose digital camera is used, and thus, the value of the evidence can be achieved.

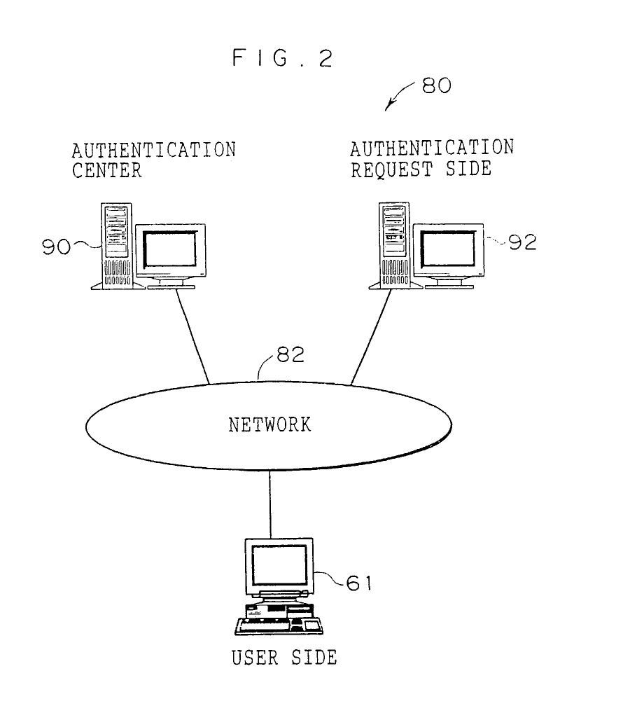

FIG. 2 is a diagram illustrating the schematic configuration of a network system 80, to which the authentication system 70 is applied. In the present embodiment, the network system 80 is configured by including a network 82 represented by the Internet or other networks such as a LAN (abbreviating a Local Area Network) serving as a communication medium.

To the network 82 represented by the Internet are connected a computer 90 on the authentication center side, belonging to the authentication center 62, a computer 92 on the authentication request side, belonging to the authentication request side 64, and the user computer 61 belonging to the user of the digital camera 10 and the memory card 42 via connecting devices such as a modem, a router or a TA (abbreviating a terminal adapter), respectively. These computers are configured in such a manner as to be able to transmit and receive information by interactive communication via the network 82.

In the network 82, mutual connection can be achieved via the connecting devices such as a modem or a router. The computers on the above-described network can mutually access to each other according to a predetermined communication protocol such as a TCP/IP (abbreviating a Transmission Control Protocol/Internet Protocol).

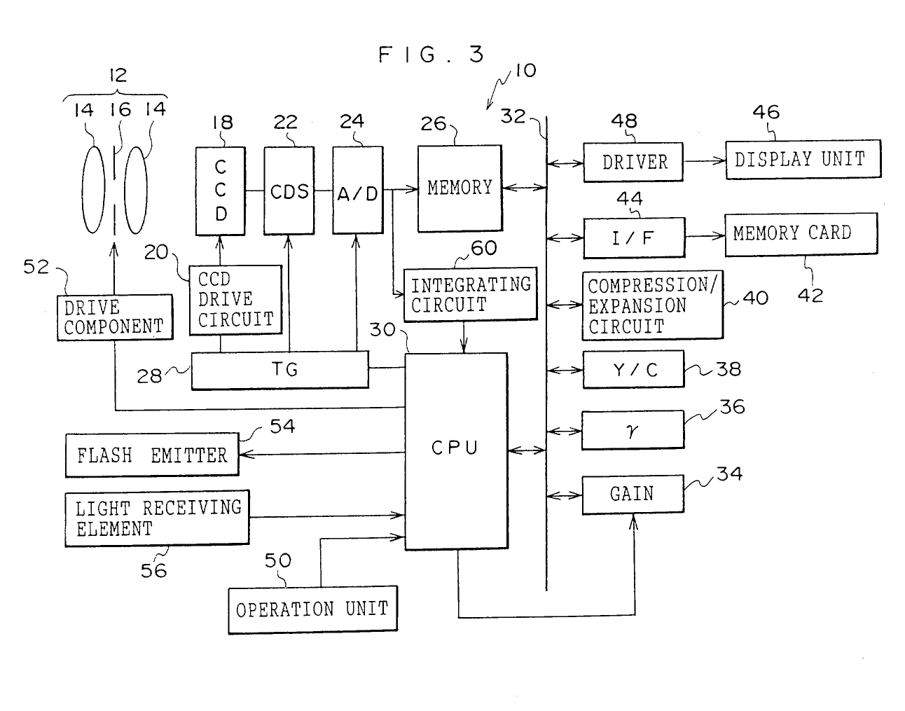

FIG. 3 is a block diagram illustrating the digital camera 10. A photographic optical system 12 in the digital camera 10 includes a photographing lens 14 and an diaphragm 16. The photographing lens 14 is constituted of one lens or a plurality of lenses, for example, having a single focus distance (a fixed focus).

An image of a subject focused on a light receiving surface of a CCD 18 via the photographic optical system 12 is converted into a signal electric charge in quantity according to the incident intensity by sensors. The signal electric charges accumulated in the above-described manner are read out by the use of a CCD drive pulse applied from a CCD drive circuit 20, and then, are output in sequence from the CCD 18 as voltage signals (i.e., analog image signals) according to the signal electric charges.

In the CCD 18, there is provided a shutter drain via a shutter gate, which is driven by the use of a shutter gate pulse, whereby the accumulated signal electric charges can be swept out to the shutter drain. That is to say, the CCD 18 is provided with a so-called electronic shutter function of controlling the accumulation time (i.e., a shutter speed) of the electric charges accumulated in the sensors by the use of the shutter gate pulse.

A signal read out of the CCD 18 is subjected to correlated dual sampling (abbreviated as “CDS”) in a CDS circuit 22, followed by color separation into color signals of R, G and B, and thus, the signal level of each of the color signals is adjusted.

The resultant image signal through the above-described predetermined analog signal processing is added into an A/D converter 24, which then converts the image signal into digital signals of RGB, and thereafter, is temporarily stored in a memory 26.

A timing signal generating circuit (abbreviated as “a TG”) 28 transmits appropriate timing signals to the CCD drive circuit 20, the CDS circuit 22 and the A/D converter 24, respectively, according to a command transmitted from a CPU 30. Thus, each of the circuits is adapted to be driven in synchronization with the timing signal transmitted from the timing signal generating circuit 28.

The CPU 30 is a control unit for centrally controlling the circuits in the digital camera 10. The CPU 30 is connected to a gain adjusting circuit 34, a gamma correction circuit 35, a luminance/chromaticity signal processing circuit (hereinafter referred to as “a YC processing circuit”) 38, a compression/expansion circuit 40, a card interface 44 for the memory card 42, a display driver 48 for driving a display unit 46, and a communication unit via a bus 32.

The CPU 30 controls a corresponding circuit block in response to an input signal transmitted from an operation unit 50, and further, controls a zooming operation or an auto-focusing (AF) operation of the photographing lens 14, and controls an auto-exposure (AE) operation.

The operation unit 50 includes a release button for giving an instruction of start of image recording, a camera mode selecting component, a zooming component and other various kinds of input components. These input components are constituted in various forms of a switch button, a dial, a slide type knob and the like. Otherwise, a desired item may be selected by a cursor by displaying a setting menu or a selection item on a screen of a touch panel or a liquid crystal monitor display unit. The operation unit 50 may be disposed in a camera body, or may be constituted as a remote control transmitter in separation from the camera body.

The CPU 30 performs various operations such as a focus evaluating operation and the AE operation in response to the image signal output from the CCD 18. The CPU 30 controls a drive component (for example, an AF motor, an iris motor or the like) 52 for the photographing lens 14 and the diaphragm 16 based on the operations, so as to move a focus lens to a focus position and sets the diaphragm 16 at a proper diaphragm value.

For example, a contrast AF system, in which the focus lens is moved in such a manner as to maximize the high frequency component of a G signal, is used as the AF control. In the AE control, the luminance of the subject (i.e., a photographing EV) is obtained based on a sum value obtained by integrating the R, G and B signals of one frame, a diaphragm value and a shutter speed are decided based on the resultant photographing EV, the diaphragm 16 is driven via the drive component 52, and further, the electric charge accumulation time of the CCD 18 is controlled by an electronic shutter in such a manner as to achieve the decided shutter speed. Consequently, optimum exposure adjustment can be achieved and auto-focusing can be achieved only by directing the photographing lens 14 in the digital camera 10 toward the subject.

During the photographing and the recording, an accurate photographing EV is obtained by repeating the above-described light measuring operation a plurality of times at the time of “half depression” of the release button, and then, the diaphragm value and the shutter speed at the time of the photographing are finally decided based on the resultant photographing EV. The diaphragm 16 is driven in such a manner that the finally decided diaphragm value is achieved at the time of “full depression” of the release button, and further, the electric charge accumulation time is controlled by the electronic shutter in such a manner that the finally decided shutter speed is achieved. Incidentally, the AE and the AF are controlled not only in response to the image signal given by the CCD 18 but also by using a known light measuring sensor or a distance measuring sensor consisting of an AF light projecting/receiving sensor.

Furthermore, the digital camera 10 includes a flash emitter 54 and a light receiving element 56 for dimming light. The digital camera 10 is set to “a low luminance automatic light emitting mode”, in which the flash emitter 54 is automatically made to emit the light at a low luminance, “a forced light emitting mode”, in which the flash emitter 54 is made to emit the light irrespective of the luminance of the subject, or “a light emission prohibiting mode”, in which the light emission by the flash emitter 54 is prohibited, according to the operation of a flash mode setting button contained in the operation unit 50.

The CPU 30 controls electric charging of a main capacitor of the flash emitter 54 or an electric discharging (i.e., light emitting) timing to a light emitting tube (for example, a xenon tube) according to the flash mode selected by the user, and further, controls the stopping of the light emission based on the measurement result supplied from the light receiving element 56. The light receiving element 56 receives light reflected on the subject which is lighted by the light emitted from the flash, and then, converts the light into an electric signal according to the receiving intensity. A signal from the light receiving element 56 is integrated by an integration circuit. When the integrated receiving intensity reaches a predetermined proper receiving intensity, the light emission from the flash is stopped.

The data output from the A/D converter 24 is stored in the memory 26, and further, is added to an integrating circuit 60. The integrating circuit 60 divides a photographed screen into a plurality of blocks (for example, 8×8=64 blocks), and sums the G signals received in the blocks. Luminance signals (i.e., Y signals) may be summed by producing the luminance signals based on the R, G and B data. Otherwise, an AE operation circuit may serve as the integrating circuit 60. Information on a summed value (i.e., an operation result) obtained by the integrating circuit 60 is input into the CPU 30.

The CPU 30 calculates an evaluation value E of the photographing screen according to a predetermined algorithm based on the information transmitted from the integrating circuit 60, and then, decides a gain value (i.e., an amplification rate) in the gain adjusting circuit 34 by the use of the obtained evaluation value E. The CPU 30 controls a gain quantity in the gain adjusting circuit 34 according to the decided gain value.

The R, G and B image data stored in the memory 26 are transmitted to the gain adjusting circuit 34, followed by amplification. The amplified image data are subjected to gamma correction in the gamma correction circuit 36, and thereafter, are transmitted to the YC processing circuit 38, in which the R, G and B image data are converted into luminance signals (i.e., the Y signals) and chromaticity signals (i.e., Cr and Cb signals).

Incidentally, the CPU 30 can perform white balance processing, if necessary.

The luminance/chromaticity signals (hereinafter abbreviated as “YC signals”) produced in the YC processing circuit 38 are written back in the memory 26. The YC signals stored in the memory 26 are supplied to the display driver 48, in which they are converted into signals of a predetermined system (for example, color composite video signals of an NTSC system), and then, are output to the display unit 46. As the display unit 46 is used a liquid crystal display or other display devices capable of color displaying. Here, the display unit 46 may be of a type capable of YC signal input or a type capable of RGB signal input. A driver according to the display device is used.

The image data is periodically rewritten in response to the image signal output from the CCD 18. The image caught by the CCD 18 is displayed on the display unit 46 as motion pictures (i.e., live images) at real time or as substantially sequential images, although not at real time, by supplying a video signal produced based on the image data to the display unit 46.

The display unit 46 can be used as an electronic viewfinder. A photographer can confirm an image displayed on the display unit 46 or an image to be photographed by an optical finer. Recording image data is started to be taken in according to a predetermined recording instruction (photographing starting instruction) operation such as a depressing operation of the release button.

When the photographer inputs an instruction of photographing and recording in the operation unit 50, the CPU 30 sends a command to the compression/expansion circuit 40, if necessary. And then, the compression/expansion circuit 40 compresses the YC data stored in the memory 26 according to JPEG or other predetermined formats. The compressed image data is recorded in the memory card 42 via the card interface 44.

In the case of the selection of a mode in which non-compressed image data is recorded (i.e., a non-compression mode), the compression/expansion circuit 40 does not perform the compression, and the non-compressed image data is recorded in the memory card 42 as it is.

Incidentally, the memory 26 is adapted to temporarily store the image data, which cannot be taken directly to the outside from the memory 26. Therefore, the image data stored in the memory 26 is not taken to the outside but is stored directly in the memory card 42. Consequently, the image data is prevented from being falsified before it is encrypted on the side of the memory card 42.

In the digital camera 10 in the present embodiment, the memory card 42 is used as a component for storing the image data therein. Specifically, for example, a recording medium such as a smart medium is used. The mode of the recording medium is not limited to the aforementioned example. Examples include various modes such as a PC card, a micro drive, a multi media card (abbreviated as “an MMC”), a magnetic disk, an optical disk, a magneto-optical disk and a memory stick. There are used a signal processing component and an interface according to a medium to be used.

In a reproduction mode, the image data read out of the memory card 42 is expanded by the compression/expansion circuit 40, and then, is output to the display unit 46 via the display driver 48.

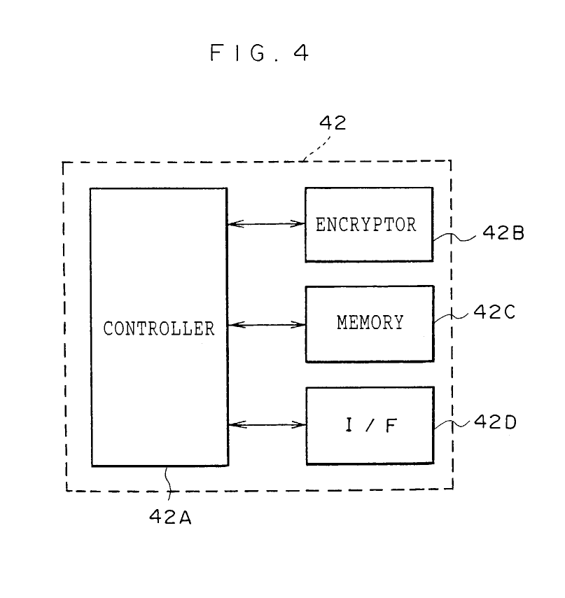

FIG. 4 is a block diagram schematically illustrating the memory card 42. As illustrated in FIG. 4, the memory card 42 includes a controller 42A, an encryptor 42B, a memory 42C and an interface (abbreviated as “an I/F”) 42D.

The controller 42A centrally controls the encryptor 42B, the memory 42C and the interface 42D. The controller 42A outputs the data on the image photographed by the digital camera 10, which is taken via the interface 42D, to the encryptor 42B. Consequently, the encryptor 42B encrypts the image data in encryption unique to the memory card 42. The encrypted image data is stored in the memory 42C.

Furthermore, a serial number is previously stored in the memory 42C, and it is provided for the authentication center side 62 together with the image data, although the details will be described later. Consequently, the image data can be decrypted with a decryption key corresponding to the serial number on the authentication center side 62.

Incidentally, the encryptor 42B corresponds to the encryption component according to the invention; and the memory 42C corresponds to the storage component according to the invention.

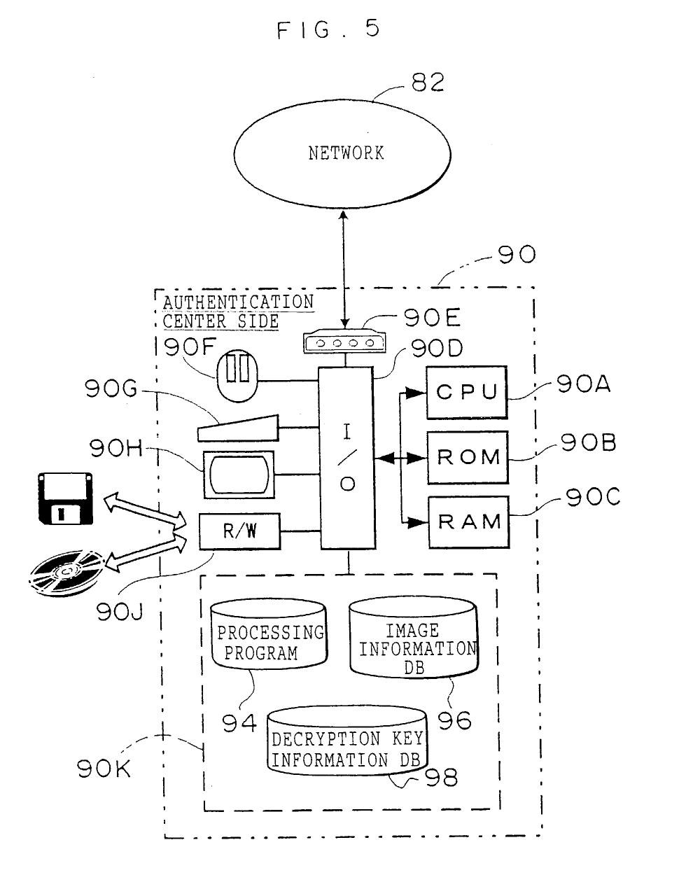

FIG. 5 illustrates the schematic configuration of the computer 90 on the side of the authentication center. The computer 90 on the side of the authentication center includes a CPU 90A, a ROM 90B, a RAM 90C and an input/output port (abbreviated as “an I/O”) 90D, which are connected to each other via buses such as an address bus, a data bus and a control bus.

To the input/output port 90D are connected a communication device 90E, a mouse 90F serving as a pointing device and a keyboard 90G used as various kinds of input/output equipment, a display 90H consisting of a CRT or an LCD, a recorder (R/W) 90J for performing at least either one of reading and writing data or a command from and in a storage medium, and a storage device 90K such as a hard disk device for storing various kinds of data or databases therein, described later, respectively.

The storage device 90K includes a file 94 storing therein a processing program such as a processing routine, described later, an image information database 96 storing the registered image data therein, and a decryption key information database 98 storing therein information on a decryption key for the memory card 42. Moreover, the decryption key information database 98 stores therein the information on the decryption key assigned per serial number of the memory card 42.

The communication device 90E is connected to the network 82 in such a manner as to freely transmit and receive the information via interactive communication with other computers. Examples of the communication device 90E include connectors such as a modem, a router, a terminal adapter (abbreviated as “a TA”) for the purpose of the connection to a telephone line or the Internet.

The recorder 90J may include a flexible disk unit (abbreviated as “an FDU”), into or from which a flexible disk serving as a storage medium can be inserted or drawn. Here, the processing routine or the like, described later, can be read from and written in the flexible disk by the use of the FDU. Therefore, the processing routine or the like, described later, may not be stored in the ROM 90B, but may be previously recorded in the flexible disk, such that the processing program recorded in the flexible disk via the FDU may be executed. In the present embodiment, the processing program recorded in the storage medium such as the flexible disk is stored (i.e., installed) in the storage device 90K of a large capacity such as a hard disk device incorporated in the computer 90 on the side of the authentication center, and thus, the processing is executed. Here, examples of the storage medium include disks such as a CD-ROM, an MD, an MO and a DVD and a magnetic tape such as a DAT. When the aforementioned storage medium is used, a CD-ROM device, an MD device, an MO device, a DVD device, a DAT device or the like is used in place of or in addition to the above-described FDU.

Incidentally, the basic configuration of each of the computer 92 on the authentication request side and the user computer 61 is substantially similar to the configuration of the computer 90 on the side of the authentication center, and further, it is the configuration of versatile and general hardware. Therefore, the detailed explanation will be omitted herein.

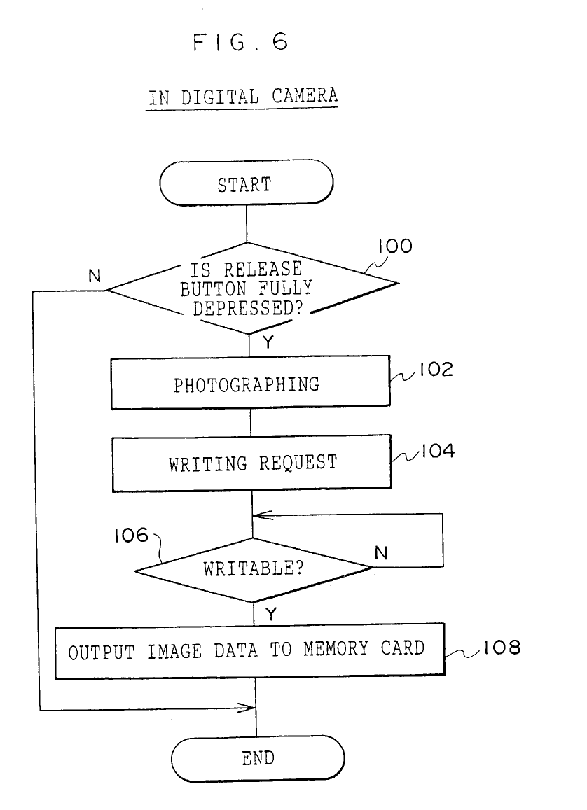

Next, explanation will be given regarding a control routine to be executed in the digital camera 10, a control routine to be executed in the memory card 42 and a control routine to be executed in the computer 90 on the side of the authentication center as the functions of the present embodiment with reference to flowcharts illustrated in FIGS. 6 to 8.

The control routine illustrated in FIG. 6 is executed when the release button is half depressed: namely, it is executed in the state in which the release button is half depressed, and further, the diaphragm value or the shutter speed is decided by the above-described AE control or AF control.

In the digital camera 10, it is determined as to whether or not the release button is fully depressed in step 100 illustrated in FIG. 6. Unless the release button is fully depressed, the determination in step 100 is negative, and thus, the present routine comes to an end.

In contrast, if the release button is fully depressed, the determination in step 100 is affirmative, the routine proceeds to step 102.

In step 102, the above-described photographing is performed, and thus, the image data is temporarily stored in the memory 26.

In step 104, a writing request signal is output to the memory card 42. In step 106, it is determined as to whether or not a writing allowable signal representing that writing is allowed is received from the memory card 42. Unless the allowable signal is received, the determination in step 106 is negative, and thus, the routine waits for the reception of the allowable signal. Here, if the signal is not received despite of a wait for a predetermined period of time, the present routine may be forcibly ended as a time-out.

In contrast, if the allowable signal is received, the determination in step 106 is affirmative. In next step 108, the image data temporarily stored in the memory 26 is output to the memory card 42 via the card interface 44. As described above, the image data cannot be taken to the outside directly from the memory 26 and the image data stored in the memory 26 is stored directly in the memory card 42, so that the image data can be prevented from being falsified before it is recorded in the memory card 42.

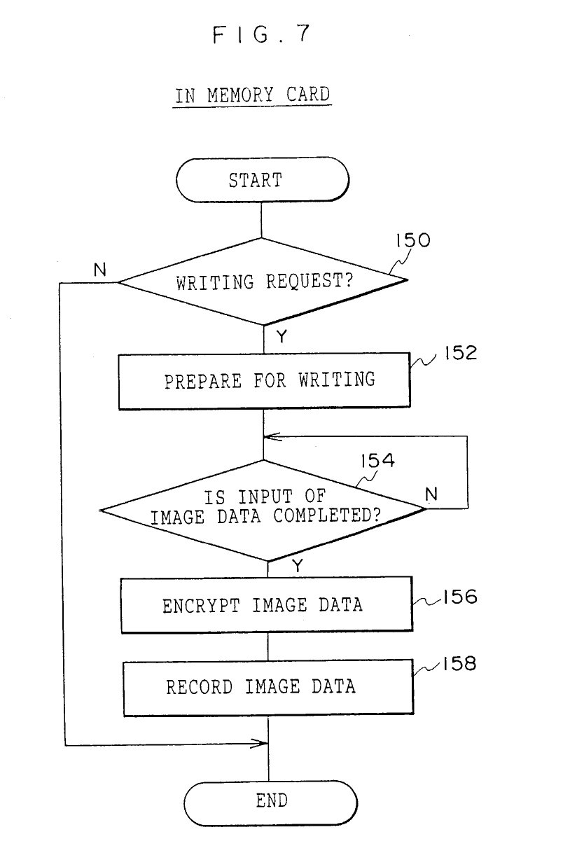

Subsequently, explanation will be made on the control routine to be executed in the controller 42A of the memory card 42 with reference to the flowchart illustrated in FIG. 7. This control routine is executed every predetermined time.

In step 150 illustrated in FIG. 7, it is determined on the side of the memory card 42 as to whether or not a writing request signal is received from the digital camera 10. Unless the writing request signal is received, the determination in step 150 is negative, and thus, the present routine comes to an end.

In contrast, if the writing request signal is received, the determination in step 150 is affirmative, the routine proceeds to step 152.

In step 152, preparation processing required for writing in the memory 42C is performed, and then, the writing allowable signal is output to the digital camera 10. Consequently, the image data transmitted from the digital camera 10 is temporarily stored in the memory 42C via the interface 42D.

In next step 154, it is determined as to whether or not the input of the image data is completed. If the input of the image data is completed, the determination in step 154 is affirmative, the routine proceeds to step 156.

In next step 156, the image data temporarily stored in the memory 42C is output to the encryptor 42B. As a consequence, the image data is encrypted by the encryptor 42B. The encryptor 42B encrypts the image data with an encryption key unique to the memory card 42. In this manner, it is difficult for a third party to decrypt the encrypted image data.

Furthermore, in step 158, the image data encrypted by the encryptor 42B is recorded in the memory 42C.

In this manner, the memory card 42 is provided with the function of encrypting the image data, so that it is possible to prevent the easy falsification of the image data. Therefore, it is possible to enhance the reliability in the case where the photographed image is used as various kinds of evidences. Moreover, the image photographed by a general-purpose digital camera not provided with the encrypting function also can be used as various kinds of evidences.

The encrypted image data and the serial number recorded in the memory card 42 are taken into the user computer 61 by the operation by the user in the above-described manner, and then, are transmitted to the computer 90 on the side of the authentication center via the network 82.

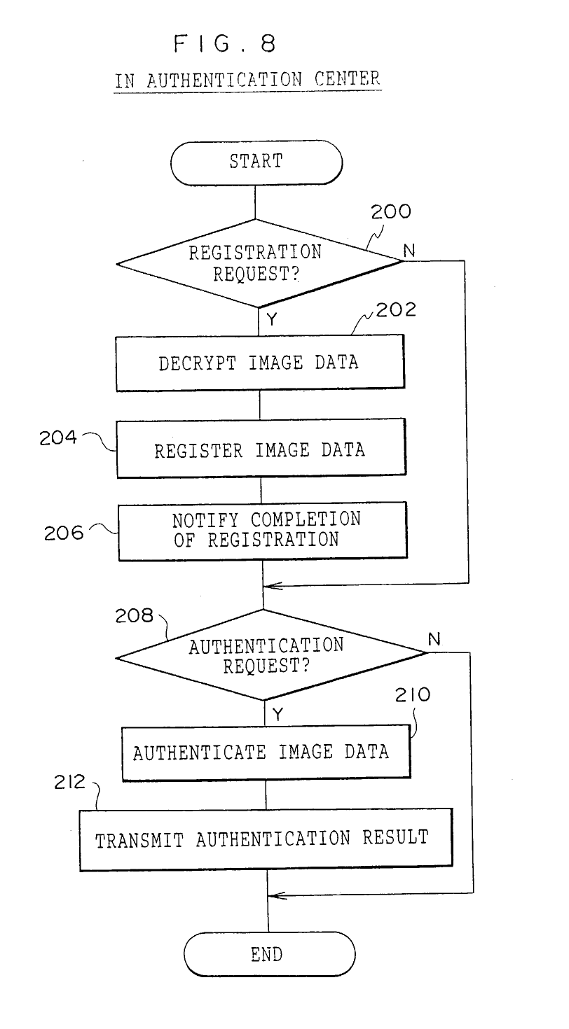

Subsequently, explanation will be made on the control routine to be executed in the controller 90 on the side of the authentication center with reference to the flowchart illustrated in FIG. 8. This control routine illustrated in FIG. 8 is executed every predetermined time.

In the controller 90 on the side of the authentication center, it is determined as to whether or not registration is requested by the user computer 61, that is, whether or not the image data and the serial number are received in step 200 illustrated in FIG. 8.

Unless the image data and the serial number are received, the determination in step 200 is negative, and then, the routine jumps to step 208. In contrast, if the image data and the serial number are received, the determination in step 200 is affirmative, the routine proceeds to step 202.

In step 202, the received image data is decrypted. Specifically, the decryption key corresponding to the received image data, that is, the decryption key corresponding to the received serial number is fetched from the decryption key information database 98, and thus, the received image data is decrypted with the fetched decryption key.

In step 204, the decrypted image data is registered in the image information database 96.

In step 206, a registration completion signal is transmitted to the user computer 61, so as to notify the user computer 61 of the registration completion. In this manner, the registration completion can be grasped on the side of the user.

In step 208, it is determined as to whether or not the authentication is requested by the computer 92 on the authentication request side, that is, whether or not the image data for the authentication request is received. Unless the image data for the authentication request is received, the determination in step 208 is negative, and thus, the present routine comes to an end. In contrast, if the image data for the authentication request is received, the determination in step 208 is affirmative, and thus, the routine proceeds to step 210.

In step 210, the received image data is authenticated. Specifically, the image data corresponding to the received image data is first specified among the image data registered in the image information database 96. This can be determined based on whether or not the names of the files, for example, match each other.

And then, the registered image data, for example, is compared with the image data transmitted from the computer 92 on the authentication request side. If both of the data match each other, information representing that the image data transmitted from the computer 92 on the authentication request side is original image data is included in authentication result information to be transmitted to the computer 92 on the authentication request side. In contrast, unless both of the data match each other, information representing that the image data transmitted from the computer 92 on the authentication request side is not the original image data is included in the authentication result information.

In step 212, the authentication result information is transmitted to the computer 92 on the authentication request side. Consequently, on the authentication request side 64, it is possible to readily grasp as to whether or not the image data is the original image data, that is, whether or not the image data is falsified. As a consequence, on the authentication request side 64, it is possible to readily determine as to whether or not the offered image data has so high reliability as to be used as evidence.

As is obvious from the above description, in the present embodiment, the memory card 42 is provided with the function of encrypting the image data, so that it is possible to prevent any easy falsification of the image data. Therefore, it is possible to enhance the reliability in the case where the photographed image is used as various kinds of evidences. Moreover, the image photographed by a general-purpose digital camera not provided with the encrypting function also can be used as various kinds of evidences.

Incidentally, although the description has been given of the case where the digital camera is used as the image picking-up component in the present embodiment, the image picking-up component is not limited to the digital camera. The invention can be applied to the case where a cellular telephone with a digital camera is used as the image photographing component.

(Second Preferred Embodiment)

Next, a explanation will be given regarding a second embodiment according to the invention. In the present embodiment, explanation will be made on the case where encryption is performed in not a memory card but a digital camera. Here, the same constituents as those in the first embodiment are designated by the same reference numerals, and therefore, the detailed explanation will be omitted herein.

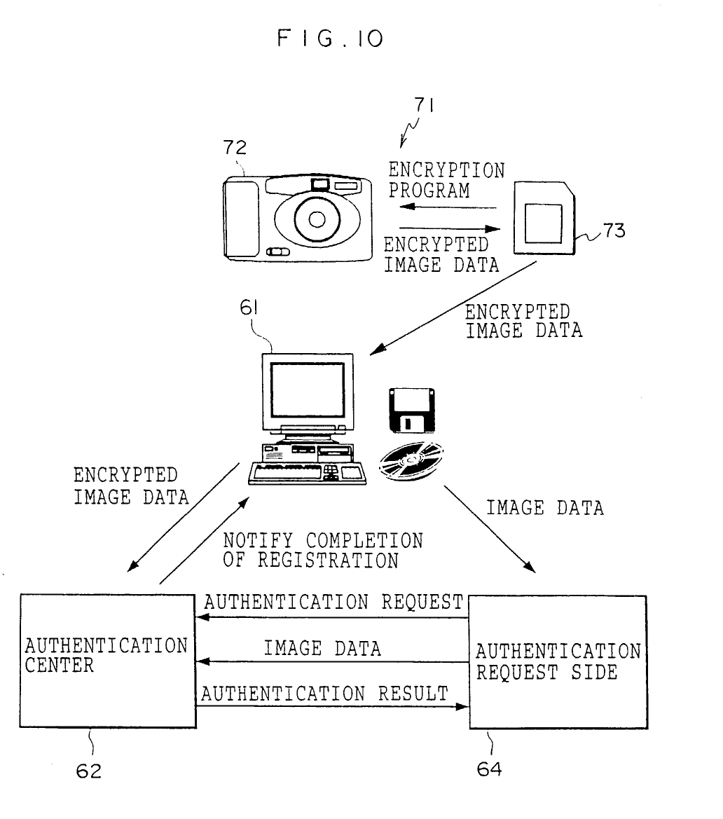

FIG. 10 is a diagram conceptually illustrating the schematic configuration of an authentication system in the present embodiment. In an authentication system 71 illustrated in FIG. 10, data on an image photographed by a digital camera 72 is recorded in a memory card 73.

The memory card 73 previously stores therein an encryption program for use in encrypting image data on an image photographed by the digital camera 72 and encryption parameters, for example, including a parameter required for encryption such as an encryption key assigned per serial number of the memory card 73, although the details will be described later. The memory card 73 is installed in the digital camera 72. In the case where the digital camera 72 requests the transmission of the encryption program, the encryption program is transmitted to the digital camera 72. In the digital camera 72, the image data on the photographed image is encrypted by using the encryption program transmitted from the memory card 73, and then, it is transmitted to the memory card 73. The authentication of the encrypted image data recorded in the memory card 73 is similar to that in the first embodiment, and therefore, its explanation will be omitted herein.

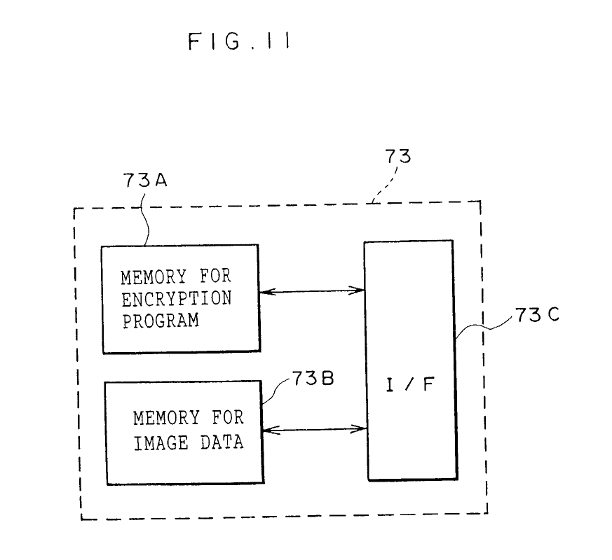

FIG. 11 is a block diagram schematically illustrating the memory card 73. As illustrated in FIG. 11, the memory card 73 includes a memory 73A for the encryption program, a memory 73B for the image data, and an interface (abbreviated as “an I/F”) 73C.

The memory 73A for the encryption program previously stores therein the encryption program for use in encrypting the image data and the encryption parameters, for example, including the parameter required for the encryption such as the encryption key assigned per serial number of the memory card 73, card type information representing a memory card for authenticating the image data, and the like. Furthermore, the memory previously stores therein the serial number, which is provided for the authentication center side 62 together with the image data. Consequently, the image data can be decrypted with a decryption key corresponding to the serial number on the authentication center side 62.

The memory 73B for the image data stores therein the encrypted image data transmitted from the digital camera 72.

The I/F 73C transmits the encryption program and the encryption parameters stored in the memory 73A for the encryption program to the digital camera 72 at the request from the digital camera 72. Moreover, in the case where the encrypted image data is received from the digital camera 72, the received image data is stored in the memory 73B for the image data.

Here, the memory 73A for the encryption program corresponds to the encryption program storage component according to the invention; the memory 73B for the image data corresponds to the image data storage component according to the invention; and the I/F 73C corresponds to the transmission/reception component according to the invention.

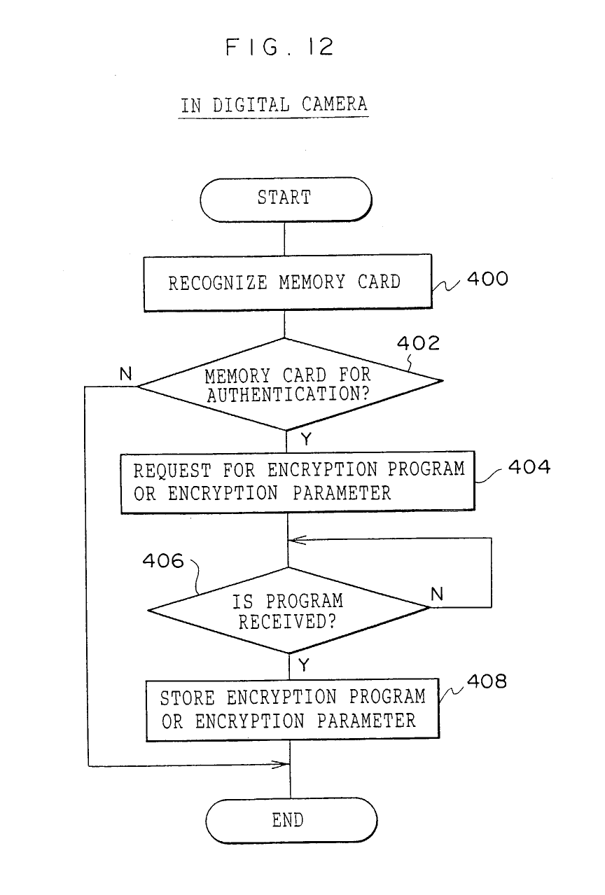

Next, explanation will be given regarding a control routine to be executed in the digital camera 72 and a control routine to be executed in the memory card 73 as the functions of the present embodiment with reference to flowcharts illustrated in FIGS. 12 to 14. Here, a control routine to be executed at the authentication center is similar to that in the first embodiment, and therefore, its explanation will be omitted herein.

The control routine illustrated in FIG. 12 is executed when the memory card 73 is installed in the digital camera 72.

In step 400, it is recognized as to what type the memory card 73 is. The memory card can be recognized by, for example, reading card type information representing the type of memory card, which has been previously stored in the memory card 73.

In step 402, it is determined as to whether or not the recognized memory card is a memory card for authenticating the image data. Unless the recognized memory card is a memory card for authenticating the image data, the determination in step 402 is negative, the present routine comes to an end.

In contrast, if the recognized memory card is a memory card for authenticating the image data, the determination in step 402 is affirmative. And then, in step 404, a request signal for requesting the encryption program and the encryption parameter is transmitted to the memory card 73.

In step 406, it is determined as to whether or not the encryption program and the encryption parameter are received. Unless they are received, the determination in step 406 is negative, and thus, the routine waits for the reception of the encryption program and the encryption parameter. Here, if the signal is not received despite of a wait for a predetermined period of time, the present routine may be forcibly ended as a time-out.

In contrast, if the encryption program and the encryption parameter are received, the determination in step 406 is affirmative. Thereafter, in step 408, the received encryption program and encryption parameter are stored in, for example, a memory 26. Incidentally, the encryption program and encryption parameter stored in the memory 26 may be erased when, for example, a power source of the digital camera 72 is turned off.

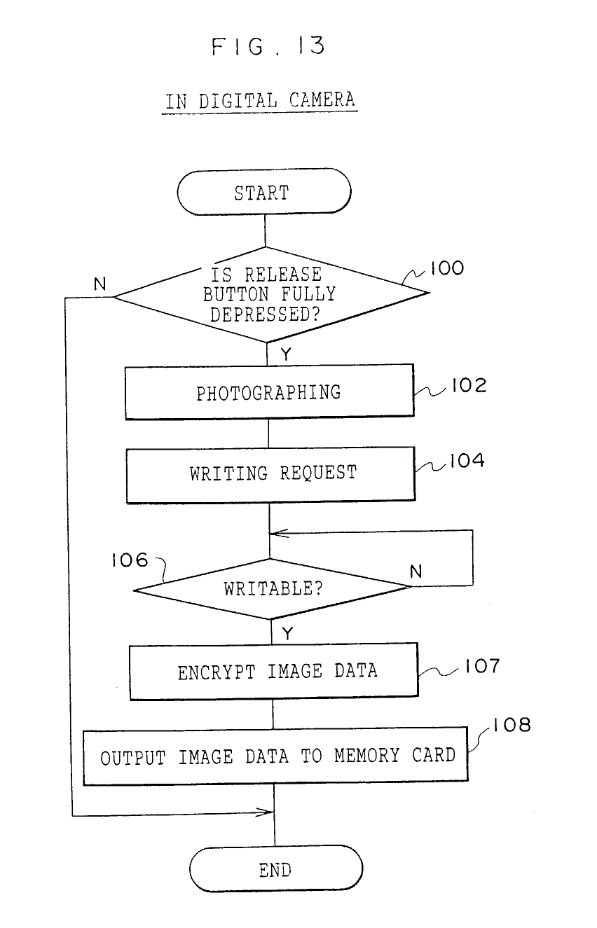

FIG. 13 is a flowchart illustrating an image data writing routine. Here, steps, in which the same processing is performed as that illustrated in FIG. 6, are designated by the same reference numerals. The control routine illustrated in FIG. 13 is substantially the same as that illustrated in FIG. 6 except for processing in step 107. In other words, in the present embodiment, the digital camera 72 encrypts the image data by the use of the encryption program and the encryption parameter, which have been previously transmitted from the memory card 73 and stored in the memory 26, before the image data on the photographed image is output to the memory card 73. As a consequence, in step 108, the encrypted image data is transmitted to the memory card 73. Other processings are the same as those illustrated in FIG. 6, and therefore, its explanation will be omitted herein.

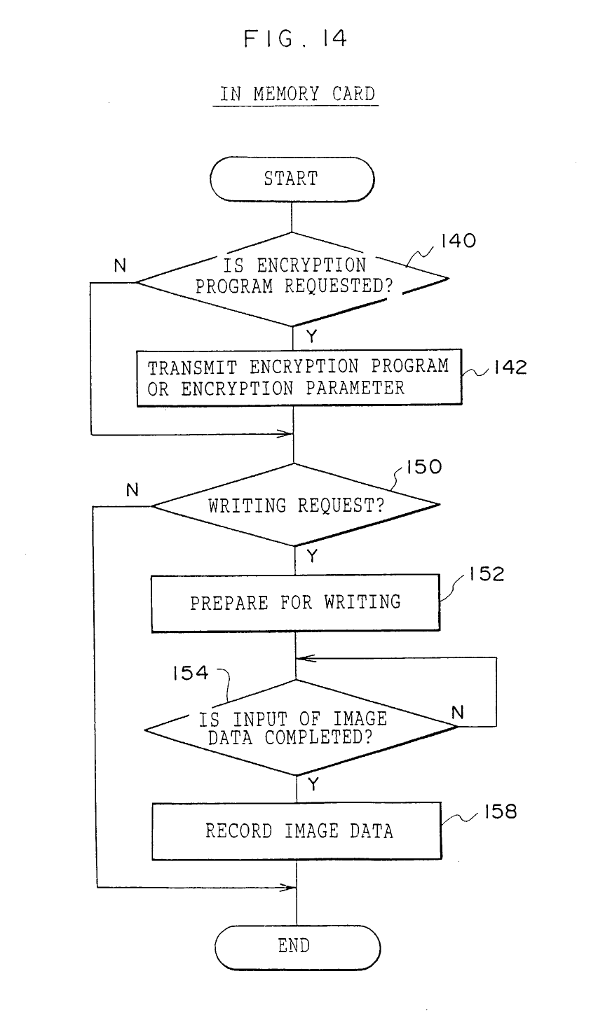

Subsequently, explanation will be made on the control routine to be executed in the I/F 73C of the memory card 73 with reference to the flowchart illustrated in FIG. 14. Incidentally, this control routine is executed every predetermined time. Here, steps, in which the same processing is performed as that illustrated in FIG. 7, are designated by the same reference numerals.

In step 140 illustrated in FIG. 14, it is determined on the side of the memory card 73 as to whether or not a request signal for requesting the transmission of the encryption program and the encryption parameter is received from the digital camera 72. Unless the request signal is received, the determination in step 140 is negative, and then, the routine jumps to step 150.

In contrast, if the request signal is received, the determination in step 140 is affirmative. In step 142, the encryption program and the encryption parameter stored in the memory 73A for the encryption program are read, and then, are transmitted to the digital camera 72. Thus, the image data is encrypted on the side of the digital camera 72. As a consequence, as illustrated in FIG. 14, the encryption of the image data, which is performed in step 156 illustrated in FIG. 7, is omitted. Other processings are the same as those illustrated in FIG. 7, and therefore, its explanation will be omitted herein.

As is obvious from the above description in the present embodiment, the encryption of the image data is performed not on the side of the memory card 73 but on the side of the digital camera 72 by transmitting the encryption program and the encryption parameter to the digital camera 72. Thus, it is unnecessary to provide a function of encrypting the image data for the memory card 73, thereby achieving the simple configuration of the memory card 73 at a reduced cost.

Incidentally, although the description has been given of the case where the encryption program and the encryption parameter are transmitted to the digital camera in the present embodiment, this is not limited to the above-described case. For example, as long as the encryption program per se is unique to the memory card, only the encryption program may be transmitted to the digital camera. In this case, a decryption program respectively corresponding to the encryption program is provided on the side of the authentication center.

It is to be understood that the invention is not restricted to the particular embodiment given above, and that various modifications and alterations can be added thereto without departing from the scope of the invention.

What is claimed is:

1. A memory card for a digital camera, for recording data of an image photographed using a digital camera, the memory card for a digital camera comprising:
an encryption component for encrypting the image data using a predetermined algorithm; and
a storage component for storing the image data encrypted by the encryption component.

2. The memory card for a digital camera of claim 1, wherein the encryption component encrypts in encryption which can be decrypted at an authentication center for registering offered image data, and supplying, to an authentication request side, a comparison result of image data for which authentication has been requested by the authentication request side with the registered image data.

3. The memory card for a digital camera of claim 2, wherein:
the encryption component encrypts the image data with an encryption key unique to the memory card for a digital camera; and
the authentication center decrypts the image data with a decryption key corresponding to the encryption key.

4. The memory card for a digital camera of claim 3, wherein the encryption key unique to the memory card for a digital camera is assigned according to a serial number of the memory card.

5. A memory card for a digital camera, for recording data of an image photographed by a digital camera, the memory card for a digital camera comprising:
an encryption program storage component for storing therein, in advance, an encryption program, on the basis of which the image data is encrypted using a predetermined algorithm;
a transmission/reception component for transmitting the encryption program to the digital camera at the request of the digital camera and receiving the image data encrypted by the digital camera; and
an image data storage component for storing the encrypted image data therein.

6. A method of recording, in a memory card for a digital camera, data of an image photographed by a digital camera, the recording method comprising the steps of:
(a) encrypting the image data with a predetermined algorithm; and
(b) storing the encrypted image data.

7. The method of recording image data of claim 6, wherein in step (a), the encryption is performed in encryption which can be decrypted at an authentication center for registering offered image data, and supplying, to an authentication request side, a comparison result of image data for which authentication has been requested by the authentication request side with the registered image data.

8. The method of recording image data of claim 7, wherein: in step (a), the image data is encrypted with an encryption key unique to the memory card for a digital camera; and
the authentication center decrypts the image data with a decryption key corresponding to the encryption key.

9. The method of recording image data of claim 8, wherein the encryption key unique to the memory card for a digital camera is assigned according to a serial number of the memory card.

10. A method of recording, in a memory card for a digital camera, data of an image photographed by a digital camera, the method comprising the steps of:
storing, in advance, an encryption program, on the basis of which the image data is encrypted with a predetermined algorithm;
transmitting the encryption program to the digital camera at the request of the digital camera and receiving the image data encrypted by the digital camera; and
storing the encrypted image data.

11. An authentication system for authenticating image data, the authentication system comprising:
a digital camera for photographing image data;
a memory card for receiving the photographed image data from the digital camera, encrypting the image data using a predetermined algorithm, and recording the image data;
an authentication center for decrypting the encrypted image data, and registering the image data; and
a computer on an authentication request side, for requesting the authentication center to authenticate the image data;
wherein the authentication center transmits, to the computer on the authentication request side, a comparison result of the image data for which authentication has been requested by the computer on the authentication request side with the registered image data.

12. The authentication system of claim 11, wherein the memory card encrypts the image data with an encryption key unique to the memory card; and
the authentication center decrypts the image data with a decryption key corresponding to the encryption key.

13. The authentication system of claim 12, wherein the encryption key unique to the memory card is assigned according to a serial number of the memory card.

14. The authentication system of claim 11, wherein the memory card receives the image data photographed by the digital camera directly from the digital camera in such a manner as to prevent any falsification of the image data.

15. A method of authenticating image data comprising, the method comprising the steps of:
(a) photographing image data using a digital camera;
(b) receiving the photographed image data via a memory card;
(c) encrypting the received image data using a predetermined algorithm via the memory card and recording the image data in the memory card;
(d) decrypting the encrypted image data using an authentication center and registering the decrypted image data at the authentication center;
(e) requesting the authentication center to authenticate the image data, using a computer on an authentication request side; and
(f) transmitting, to the computer on the authentication request side, a comparison result of the image data for which authentication has been requested by the computer on the authentication request side with the registered image data, by the authentication center.

16. The authentication method of claim 15, wherein the memory card encrypts the image data with an encryption key unique to the memory card in step (c); and
the authentication center decrypts the image data with a decryption key corresponding to the encryption key, in step (d).

17. The authentication method of claim 16, wherein the encryption key unique to the memory card is assigned according to a serial number of the memory card.

18. The authentication method of claim 15, wherein in step (b), the memory card receives the image data photographed by the digital camera directly from the digital camera in such a manner as to prevent any falsification of the image data.
